(19) United States
(12) Patent Application Publication
(10) Pub. No.: US 2008/0275686 A1
(43) Pub. Date: Nov. 6, 2008

(54) ENVELOPE TECHNIQUE FOR EXCLUSION OF ATOMS IN AN HBOND CHECK

(76) Inventors: Timothy John Mullins, Rochester, MN (US); Roy Glenn Musselman, Rochester, MN (US); Yuan-Ping Pang, Rochester, MN (US); Kurt Walter Pinnow, Rochester, MN (US); Brian Paul Wallenfelt, Eden Prairie, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/742,929

(22) Filed: May 1, 2007

(51) Int. Cl. G06G 7/48

(52) U.S. Cl. 703/12

(57) ABSTRACT

A technique for reducing the number of actions performed as part of a molecular modeling simulation is disclosed. For example, embodiments of the invention may be used to reduce the number of comparisons performed in a simulation of binding affinity between a first molecule (e.g., a protein receptor site) and a second molecule (e.g., a ligand). Because such a simulation is typically performed a very large number of times for even one particular first and second molecule, and is further performed for different combinations of first and second molecules, the effect of reducing the number of comparisons is leveraged and can provide a significant impact on overall simulation performance.

### CROSS-REFERENCE TO RELATED APPLICATIONS

This application is related to U.S. patent application Ser. No. ______, Attorney Docket No. ROC920060208US1, titled “kD Tree and Envelope to Improve Identification of Nearest Atoms”, filed May 1, 2007, by Pinnow, et al; and U.S. patent application Ser. No. ______, Attorney Docket No. ROC920060209US1, titled “Miss-Accumulation in a Binary Space Partitioning Tree,” filed May 1, 2007, by Gooding, et al. These related patent applications are incorporated by reference herein in their entirety.

### BACKGROUND OF THE INVENTION

1. Field of the Invention

The present invention generally relates to computing techniques for modeling physical interactions between two substances at a molecular level. More specifically, the present invention relates to an envelope technique used to improve the performance of a computational simulation.

2. Description of the Related Art

Powerful computers may be designed as highly parallel systems where the processing activity of hundreds, if not thousands, of processors (CPUs) are coordinated to perform computing tasks. These systems are highly useful for a broad variety of applications including, financial modeling, hydrodynamics, quantum chemistry and mechanics, astronomy, weather modeling and prediction, geological modeling, prime number factoring, image processing (e.g., CGI animations and rendering), to name but a few examples.

One family of parallel computing systems has been (and continues to be) developed by International Business Machines (IBM) under the name Blue Gene®. The Blue Gene/L architecture provides a scalable, parallel computer that may be configured with a maximum of 65,536 (2¹⁶) compute nodes. Each compute node includes a single application specific integrated circuit (ASIC) with 2 CPU's and memory. The Blue Gene/L architecture has been successful and on Oct. 27, 2005, IBM announced that a Blue Gene/L system had reached an operational speed of 280.6 teraflops (280.6 trillion floating-point operations per second), making it the fastest computer in the world at that time. Further, as of June 2005, Blue Gene/L installations at various sites world-wide were among five out of the ten top most powerful computers in the world.

IBM is currently developing a successor to the Blue Gene/L system, named Blue Gene/P. Blue Gene/P is expected to be the first computer system to operate at a sustained 1 petaflops (1 quadrillion floating-point operations per second). Like the Blue Gene/L system, the Blue Gene/P system is scalable with a projected maximum of 73,728 compute nodes. Each compute node in Blue Gene/P is projected to include a single application specific integrated circuit (ASIC) with 4 CPU's and memory. A complete Blue Gene/P system is projected to include 72 racks with 32 node boards per rack.

In addition to the Blue Gene architecture developed by IBM, other highly parallel computer systems have been (and are being) developed. For example, a Beowulf cluster may be built from a collection of commodity off-the-shelf personal computers. In a Beowulf cluster, individual systems are connected using local area network technology (e.g., Ethernet) and system software is used to execute programs written for parallel processing on the cluster of individual systems.

As stated, these, and other, parallel systems are often used to perform simulations of molecular systems. One such type of simulation is used to determine whether one compound (referred to as a ligand) will bind to another compound (referred to as a receptor). This information is expected to lead to discoveries of new useful drugs and new medical treatment methods. For example, these simulations may be performed to identify a compound that will deliver a particular therapeutic substance to a particular location on a particular protein (e.g., a compound that will target a particular site on the surface of a cancerous cell).

In order to determine whether a compound is likely to bind with a receptor, multiple iterations of a simulation are usually performed to account for the various conformations in which the ligand and receptor may encounter one another. That is, the simulation may exhaustively evaluate the possible conformations in which the ligand may bind with the receptor. For each conformation, the simulation may be configured to determine whether the conformation is possible (i.e., likely to occur) and, if so, whether the ligand will bind with the receptor.

Given the nature of this (and other similar) problems, parallel computing has emerged as the preferred way to perform these simulations because a very large number of conformations can be tested simultaneously on the compute nodes of a parallel system. Of course, molecular simulations may be performed on more conventional computer systems; they just take significantly longer to perform.

As stated, these types of molecular simulations may first evaluate whether a given receptor/ligand conformation is physically possible. For example, one conformation may position an atom from the ligand at a point too close to an atom in the receptor. That is, the conformation may specify a state for the ligand and receptor that cannot (or is highly unlikely) to occur in the real world, based on our understanding of quantum mechanics. If the atoms are too close, then the results of any free energy calculations based on that conformation are unlikely to produce any meaningful data.

Traditionally, a brute force method is used to ensure that none of the ligand atoms are too close to the receptor atoms. That is, the simulation checks all n atoms of the ligand against all m atoms of the receptor. This leads to a runtime requirement of m*n comparisons for a single conformation. And recall, this process is usually performed for many thousands of test confirmations between a ligand and receptor, and performed for hundreds of ligands (if not thousands or more). As a result, the performance cost of performing an n*m compassion for each conformation is magnified many times.

Accordingly, as the foregoing illustrates, there remains a need for improvements in the techniques used to perform these (and other similar) types of molecular modeling simulations.

### SUMMARY OF THE INVENTION

Embodiments of the present invention provide a technique for excluding atoms from being included in a hydrogen bond (hbond) test performed as part of a computational simulation.

One embodiment of the invention includes a computer-implemented method of excluding certain atoms from being included in a hydrogen bond (hbond) test performed as part of a computational simulation. The method generally includes selecting a conformation for a first molecule and second molecule to simulate. The conformation may include a set of atoms in the first molecule, a set of atoms in the second molecule, and specify a position of the first and second molecule, relative to one another. The method also includes determining a region of space for an envelope surrounding the set of atoms in the second molecule, increasing the region of space enclosed by the envelope by an hbond distance, and determining which of the set of atoms of the first molecule are within the envelope surrounding the set of atoms in the second molecule. The method also includes, for each atom of the first molecule within the envelope surrounding the set of atoms in the second molecule, determining whether the atom of the first molecule is within a specified distance of any of the atoms of the second molecule.

Another embodiment of the invention includes a computer-readable storage medium containing a program which, when executed, performs an operation for excluding certain atoms from being included in a hydrogen bond (hbond) test performed as part of a computational simulation. The operation generally includes receiving a selection of a conformation for a first molecule and second molecule to simulate. The conformation may include a set of atoms in the first molecule, a set of atoms in the second molecule, and specify a position of the first and second molecule, relative to one another. The operation also includes determining a region of space for an envelope surrounding the set of atoms in the second molecule, increasing the region of space enclosed by the envelope by an hbond distance, and determining which of the set of atoms of the first molecule are within the envelope surrounding the set of atoms in the second molecule. The operation also includes, for each atom of the first molecule within the envelope surrounding the set of atoms in the second molecule, determining whether the atom of the first molecule is within a specified distance of any of the atoms of the second molecule.

Another embodiment of the invention includes a computing device having a compute node having at least a processer, a memory, and a simulation program, which when exeucted by the compute node, performs an operation for excluding certain atoms from being included in a hydrogen bond (hbond) test performed as part of a computational simulation. The operation may generally include receiving a selection of a conformation for a first molecule and second molecule to simulate. The conformation may include a set of atoms in the first molecule, a set of atoms in the second molecule, and specifies a position of the first and seclude molecule, relative to one another. The operation may also include also include determining a region of space for an envelope surrounding the set of atoms in the second molecule, increasing the region of space enclosed by the envelope by an hbond distance, and determining which of the set of atoms of the first molecule are within the envelope surrounding the set of atoms in the second molecule. The operation may also include, for each atom of the first molecule within the envelope surrounding the set of atoms in the second molecule, determining whether the atom of the first molecule is within a specified distance of any of the atoms of the second molecule.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level block diagram of components of a massively parallel computer system, according to one embodiment of the present invention.

FIG. 2 is a high-level diagram of a compute node of the system of FIG. 1, according to one embodiment of the invention.

FIG. 3 is a conceptual illustration of a computing cluster, according to one embodiment of the invention.

FIG. 4 illustrates a method for using an envelope technique to exclude atoms from an hbond test performed as part of a computational simulation, according to one embodiment of the invention.

FIG. 5 is a conceptual illustration of atoms in a receptor and an envelope generated around the atoms of a ligand, according to one embodiment of the invention.

FIG. 6 is a conceptual illustration of different methods for constructing an envelope around a ligand, according to embodiments of the invention.

### DETAILED DESCRIPTION OF THE PREFERRED EMBODIMENTS

Embodiments of the invention provide a technique for reducing the number of actions performed as part of a molecular modeling simulation. For example, embodiments of the invention may be used to reduce the number of comparisons performed in a simulation of binding affinity between a ligand and receptor. Because such a simulation is typically performed a very large number of times for even a single ligand and receptor, the effect of reducing the number of comparisons is leveraged and can provide a significant impact on overall simulation performance.

As described herein, rather than perform n×m comparisons for a receptor of m atoms and a ligand of n atoms, a molecular modeling simulation may be configured to determine an appropriately sized envelope defining a region of space that encloses the atoms present in the ligand. Atoms in the ligand are usually distributed more compactly and are therefore easier to define an envelope around than the atoms in a receptor, which is often much larger than the ligand. Once defined, the size of the envelope may be enlarged by an amount representing the distance over which hydrogen bonding interactions are expected to occur between the ligand and the receptor (typically a few angstroms).

Atoms from the receptor and ligand are compared against the envelope around the ligand/receptor and identified as being either inside or outside of the envelope. Atoms of the receptor that are outside of the envelope are excluded from further analysis; Atoms of the receptor that are inside of the envelope are checked against each of the atoms of the ligand to determine whether the relative positions of any two particular atoms are too close to one another. That is, whether the relative positions cannot (or are highly unlikely to) occur in the real world, based on rules governing quantum mechanical interactions. If so, the particular conformation can be skipped without performing any free energy or binding affinity calculations for that conformation. Further, the number of comparisons is reduced from (n×m) to (n+m*n*e), where e is the percentage of atoms within the envelope.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM or DVD-ROM disks readable by a CD- or DVD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

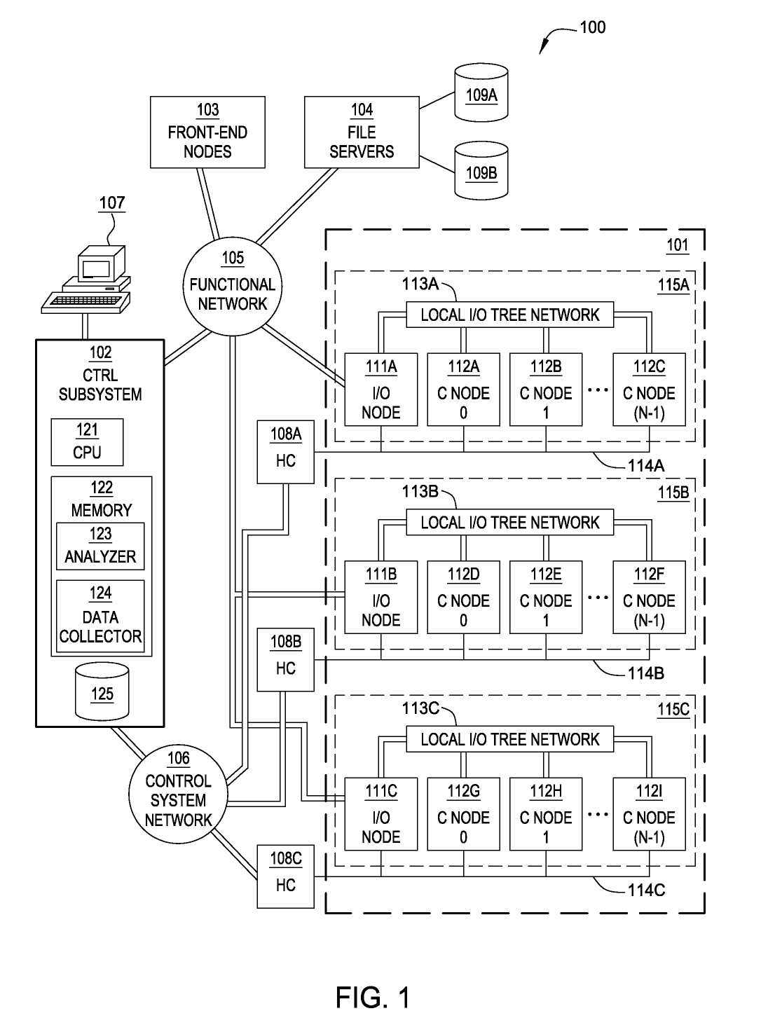

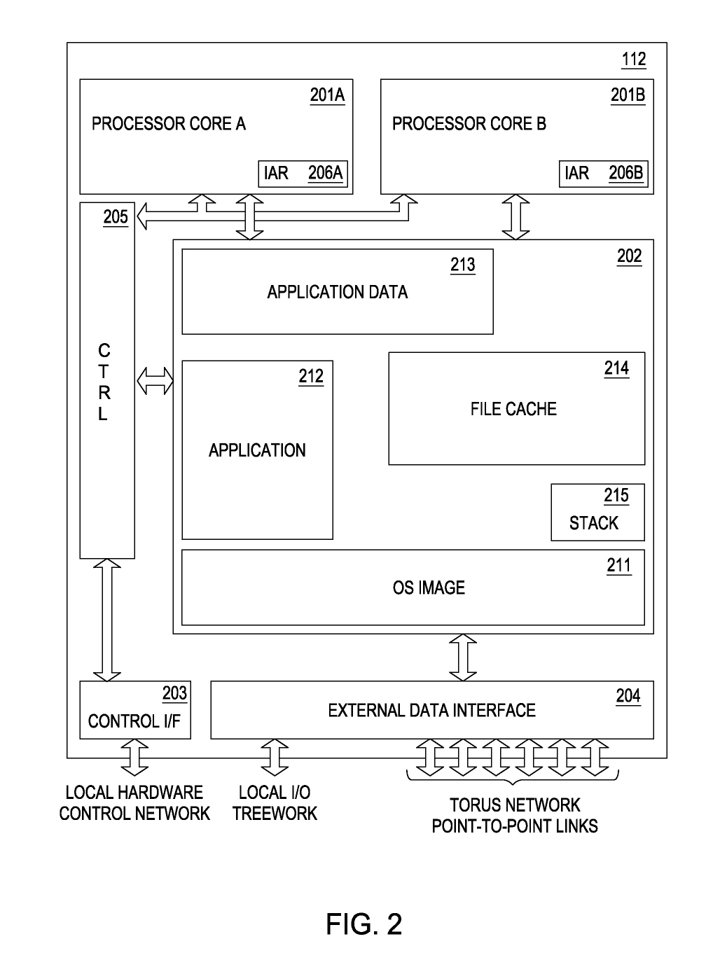

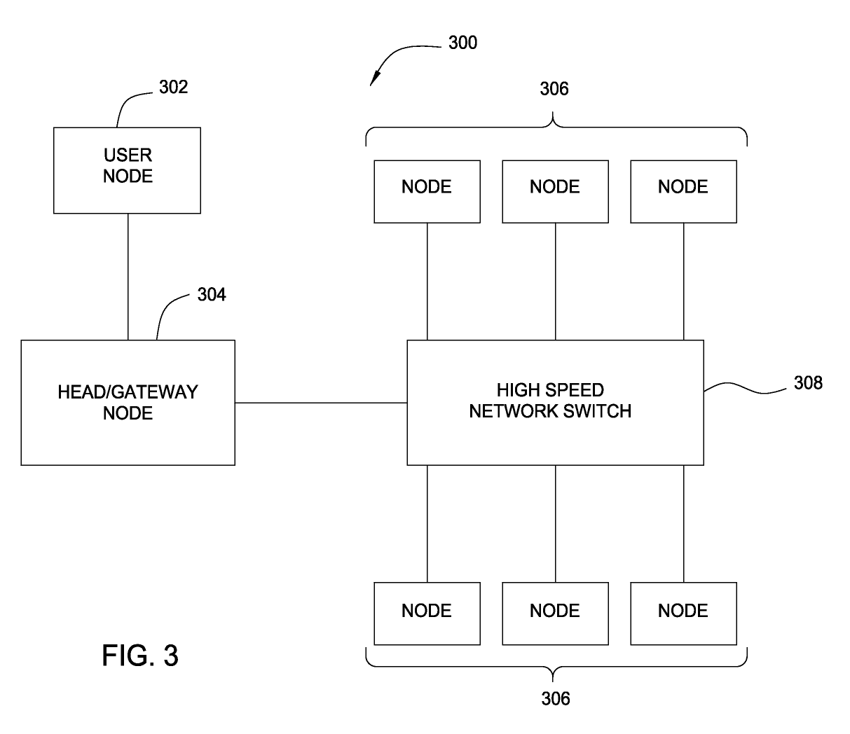

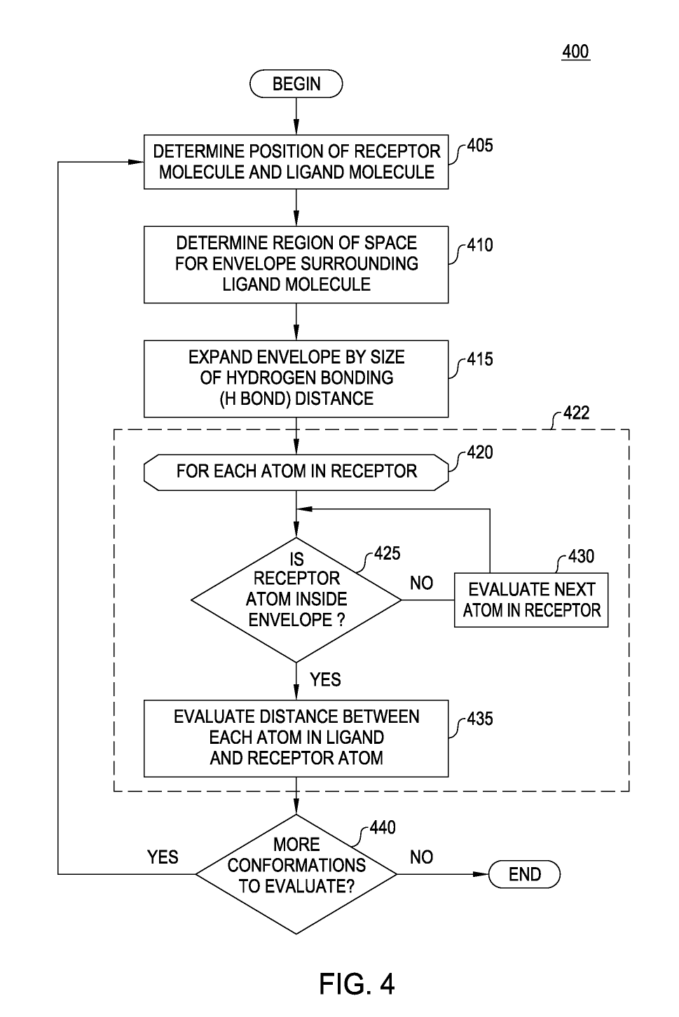

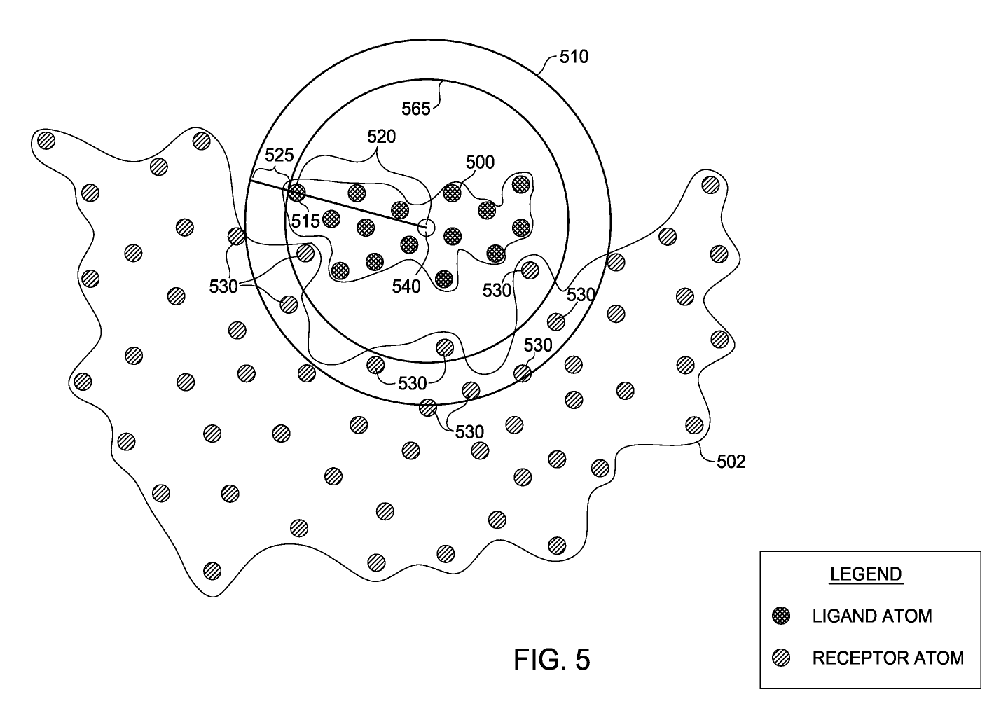

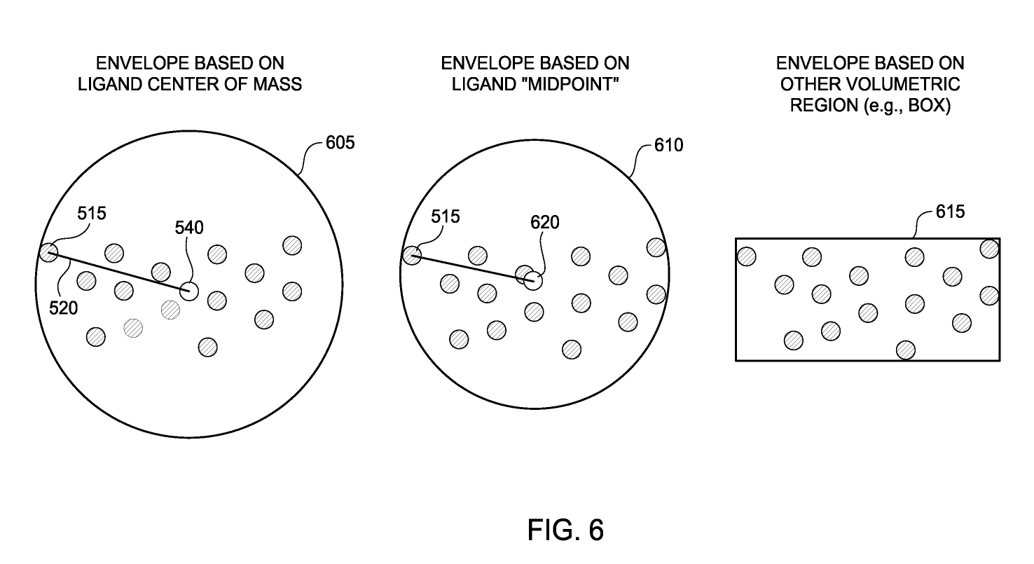

Embodiments of the invention are well suited for use with highly-parallel computer systems, such as the Blue Gene system developed by IBM. Accordingly, FIGS. 1-2 describe the general architecture of a Blue Gene system. FIG. 3 illustrates the general architecture of a Beowulf computing cluster. FIG. 4 illustrates a method for using an envelope technique to exclude of atoms from an hbond test performed as part of a computational simulation. And FIGS. 5-6 illustrate different techniques for defining an envelope to enclose a ligand.

FIG. 1 is a high-level block diagram of components of a massively parallel computer system 100, according to one embodiment of the invention. Illustratively, computer system 100 shows the high-level architecture of an IBM Blue Gene® computer system, it being understood that other parallel computer systems could be used, and the description of this architecture is not intended to limit the present invention.

As shown, computer system 100 includes a compute core 101 having a number of compute nodes arranged in a regular array or matrix, which perform the useful work performed by system 100. The operation of computer system 100, including compute core 101, may be controlled by control subsystem 102. Various additional processors in front-end nodes 103 may perform auxiliary data processing functions and file servers 104 provide an interface to data storage devices such as disk based storage 109A and 109B or other I/O (not shown). Functional network 105 provides the primary data communication path among compute core 101 and other system components. For example, data stored in storage devices attached to file servers 104 is loaded and stored to other system components through functional network 105.

Also as shown, compute core 101 includes I/O nodes 111 A-C and compute nodes 112A-I. Compute nodes 112 provide the processing capacity of parallel system 100, and are configured to execute applications written for parallel processing. I/O nodes 111 handle I/O operations on behalf of compute nodes 112. Each I/O node 111 may include a processor and interface hardware that handles I/O operations for a set of q compute nodes 112, the I/O node and its respective set of q compute nodes are referred to as a Pset. Compute core 101 contains p Psets 115A-C, each including a single I/O node 111 and q compute nodes 112, for a total of p×q compute nodes 112. The product p×q can be very large. For example, in one implementation p=1024 (1K) and q=64, for a total of 64K compute nodes.

In general, application programming code and other data input required by compute core 101 to execute user applications, as well as data output produced by the compute core 101, is communicated over functional network 105. The compute nodes within a Pset 115 communicate with the corresponding I/O node over a corresponding local I/O tree network 113A-C. The I/O nodes, in turn, are connected to functional network 105, over which they communicate with I/O devices attached to file servers 104, or with other system components. Thus, the local I/O tree networks 113 may be viewed logically as extensions of functional network 105, and like functional network 105 are used for data I/O, although they are physically separated from functional network 105.

Control subsystem 102 directs the operation of the compute nodes 112 in compute core 101. Control subsystem 102 is a computer that includes a processor (or processors) 121, internal memory 122, and local storage 125. An attached console 107 may be used by a system administrator or similar person. Control subsystem 102 may also include an internal database which maintains state information for the compute nodes in core 101, and an application which may be configured to, among other things, control the allocation of hardware in compute core 101, direct the loading of data on compute nodes 111, and perform diagnostic and maintenance functions.

Control subsystem 102 communicates control and state information with the nodes of compute core 101 over control system network 106. Network 106 is coupled to a set of hardware controllers 108A-C. Each hardware controller communicates with the nodes of a respective Pset 115 over a corresponding local hardware control network 114A-C. The hardware controllers 108 and local hardware control networks 114 are logically an extension of control system network 106, although physically separate.

In addition to control subsystem 102, front-end nodes 103 provide computer systems used to perform auxiliary functions which, for efficiency or otherwise, are best performed outside compute core 101. Functions which involve substantial I/O operations are generally performed in the front-end nodes. For example, interactive data input, application code editing, or other user interface functions are generally handled by front-end nodes 103, as is application code compilation. Front-end nodes 103 are connected to functional network 105 and may communicate with file servers 104. In one embodiment, compute nodes 112 are arranged logically in a three-dimensional torus, where each compute node may be identified using an x, y and z coordinate.

FIG. 2 is a high-level diagram of a compute node 112 of the system 100 of FIG. 1, according to one embodiment of the invention. As shown, compute node 112 includes processor cores 201A and 201B, and also includes memory 202 used by both processor cores 201; an external control interface 203 which is coupled to local hardware control network 114; an external data communications interface 204 which is coupled to the corresponding local I/O tree network 113, and the corresponding six node-to-node links of the torus network; and monitoring and control logic 205 which receives and responds to control commands received through external control interface 203. Monitoring and control logic 205 may access processor cores 201 and locations in memory 202 on behalf of control subsystem 102 to read (or in some cases alter) the operational state of node 112. In one embodiment, each node 112 may be physically implemented as a single, discrete integrated circuit chip.

As described, functional network 105 may service many I/O nodes, and each I/O node is shared by multiple compute nodes 112. Thus, it is apparent that the I/O resources of parallel system 100 are relatively sparse when compared to computing resources. Although it is a general purpose computing machine, parallel system 100 is designed for maximum efficiency in applications which are computationally intense.

As shown in FIG. 2, memory 202 stores an operating system image 211, an application code image 212, and user application data structures 213 as required. Some portion of memory 202 may be allocated as a file cache 214, i.e., a cache of data read from or to be written to an I/O file. Operating system image 211 provides a copy of a simplified-function operating system running on compute node 112. Operating system image 211 may includes a minimal set of functions required to support operation of the compute node 112. In a Blue Gene system, for example, operating system image 211 contains a version of the Linux® operating system customized to run on compute node 112. Of course, other operating systems may be used, and further it is not necessary that all nodes employ the same operating system. (Also note, Linux® is a registered trademark of Linus Torvalds in the United States and other countries.)

Application code image 212 represents a copy of the application code being executed by compute node 112. Application code image 212 may include a copy of a computer program being executed by parallel system 100, but where the program is very large and complex, it may be subdivided into portions which are executed by different compute nodes 112. For example, Application code image 212 may be configured to use an envelope technique to exclude atoms from an hbond test performed as part of a molecular modeling simulation. In such a case, when performed essentially simultaneously by as many as 65,536 compute nodes, a vast number of possible conformations between a ligand and a receptor may be evaluated. Memory 202 may also include a call-return stack 215 for storing the states of procedures which must be returned to, which is shown separate from application code image 212, although in may be considered part of application code state data.

As part of ongoing operations, application 212 may transmit messages from compute node 112 to other compute nodes in parallel system 100. For example, the high level MPI call of MPI_Send( ); may be used by application 312 to transmit a message from one compute node to another. On the other side of the communication, the receiving node may call use the MPI call MPI_Recieve( ); to receive and process the message. In context of the present invention, for example, a message may be sent from a control node to a compute node describing a conformation of a ligand and receptor to evaluate. The node may perform the simulation and then generate and transmit a message back regarding the results.

Other parallel systems also include a mechanism for transmitting messages between different compute nodes. For example, nodes in a Beowulf cluster may communicate using a using a high-speed Ethernet style network. FIG. 3 illustrates the high level architecture of a Beowulf cluster, according to one embodiment of the invention. It being understood that other parallel computer systems could be used, and the description of this architecture is not intended to limit the present invention.

FIG. 3 illustrates another example of a parallel architecture, according to one embodiment of the invention. Cluster 300 is representative of a Beowulf cluster, as well as other clustering architectures. As shown, cluster 300 includes a user node 302, gateway node 304, and compute nodes 306 connected via high-speed network switch 308. Those skilled in the art will recognize that FIG. 3 provides a simplified representation of a computing cluster, and that the nodes of a typical computing cluster include a number of additional elements.

User node 302 may provide an interface to cluster 300. As such, user node 302 allows users to create, submit, and review the results of computing tasks submitted for execution to cluster 300. As shown, user node 302 is connected to head/gateway node 304. Head/gateway node 304 connects the user node 302 to the compute nodes 306. Compute nodes 306 provide the processing power of cluster 300. As is known, clusters are often built from racks of commonly available PC components. Thus, each node 306 may include one or more CPUs, memory, hard disk storage, a connection to high speed network switch 308, and other common PC components. Like the compute nodes 112 of parallel system 100, a compute node 306 of cluster 300 may be configured to carry out molecular modeling simulations.

FIG. 4 illustrates a method 400 for using an envelope technique to exclude atoms from an hbond test, according to one embodiment of the invention. In one embodiment, the method may be performed by multiple compute nodes of a parallel computer system, like the ones illustrated in FIGS. 1-3, as part of a computational simulation to analyze binding affinity between a ligand and a receptor. Of course, one of ordinary skill in the art will recognize that the method 400 may be adapted for use on other parallel computer systems, distributed processing networks, or more conventional non-parallel computer systems.

As shown, the method 400 begins at step 405, where the position of a particular receptor molecule and ligand molecule are determined, relative to one another. For example, multiple iterations of a simulation are usually performed for the same ligand and receptor to account for the various conformations in which the ligand and receptor may encounter one another. At step 410, a region of space for an envelope surrounding the ligand molecule is determined. In various embodiments, the envelope may be based on the center of mass of the ligand, a geometric center of the ligand, or other volumetric shape used to enclose the atoms of the ligand. Examples of envelopes constructed using these techniques are shown in FIGS. 5 and 6.

At step 415, the size of the envelope may be expanded by an amount representing the distance over which hydrogen bonding interactions are expected to occur between the ligand and the receptor, referred to as an hbond limit. As expanded by the hbond limit, the envelope defines a region of space that includes any atoms of the receptor that are within the hbond limit away from any of the atom in the ligand. Conversely, any atom of the receptor that is outside of the envelope cannot be closer than the hbond limit to any of the ligand atoms. Thus, receptor atoms within the envelope are close enough for hydrogen bonding interactions to occur, but still need to be evaluated to determine whether they are too close to any of the atoms in the ligand, while receptor atoms outside of the envelope are too far hydrogen bonding interactions and need not be analyzed to determine whether they are too close to any of the atoms in the ligand.

Accordingly, at step 420, a loop begins to evaluate each atom in the receptor, relative to its position and the envelope. The steps shown in FIG. 4 within a box 422 are performed for each atom in the receptor. At step 425, a receptor atom is evaluated to determine whether the receptor atom is inside the envelope. If not, at step 430, the next atom in the receptor is selected to be evaluated. Otherwise, if the receptor atom being considered is inside the envelope, then at step 435, the distance between each atom in the ligand and the receptor atom is evaluated. If the receptor atom being considered is too close to any of the atoms in the ligand, then the particular conformation of receptor and ligand is not considered any further. Ultimately, if none of the atoms of the receptor inside the envelope are too close to any of the atoms in the ligand, then the free energy or binding affinity for that confirmation of ligand and receptor may be evaluated. Thus, only confirmations of ligand and receptor that may physically occur are evaluated, and only comparisons between selected atoms of the receptor are evaluated to determine whether they are too close to any atoms of the ligand. Therefore, embodiments of the invention provide an improved technique for performing a molecular modeling simulation that reduces the number of comparisons that are performed as part of simulation.

For example, Table I, below, compares the application of a brute force technique with the method 500 using pseudo-code. In this example, the receptor includes 277 atoms (i.e., n=277) and a ligand includes 25 atoms (i.e., m=25). Also, it is assumed that 87.3% of the atoms in the receptor are outside of the envelope.

TABLE I

| | |
|---|---|
| Brute Force technique: | Method 500: |
| for i = 0 to n | for i = 0 to n |
| for j = 0 to m | //Check distance to center of |
| //Check distance | //envelope |
| end for | if (within envelope) |
| end for | for j = 0 to m |
| Cost: (mxn comparisons) | //Check distance |
| = 277*25 | end for |
| =6925 comparisons | end if |
| | end for |
| | Cost: (n+n*m*(1−exclusion rate)) |
| | = 277 +277*25*(1−.873) |
| | = 1156 |
| | (83% fewer comparisons) |

As shown, the difference between using a brute force technique and method 500 is an 83% reduction in the number of comparisons performed for a single conformation of a ligand and receptor having the characteristics given in this example.

FIG. 5 is a conceptual illustration of atoms in a receptor 502 and an envelope generated around the atoms of a ligand 500, according to one embodiment of the invention. As shown, envelope 505 is represented as a two-dimensional circle having radius 520 surrounding atoms present in ligand 500. Of course, in practice, it is anticipated that the envelope will encompass a three-dimensional volume (e.g., by turning envelope 505 into a sphere). In different embodiments, a center 540 of envelope 505 may represent either a geometric center of the ligand 502 or the center of mass of ligand 500. In this example, radius 520 extends from a point representing the center of mass (center 540) of ligand 500 to an atom 515 in ligand 500 that is the greatest distance from center 540. Thus, all of the other atoms in ligand 500 are also inside envelope 505. Additionally, radius 520 has been extended by distance 525, representing the size of the hbond limit. This results in envelope 510. As stated, envelope 510 is constructed such that it defines a region of space which includes any atoms of receptor 502 that are within the hbond limit away from any of the atom in the ligand 500. Thus, each of the atoms 530 of receptor 510 within envelop 510 are evaluated to determine whether they are too close to an atom in the receptor, while atoms outside of envelope 510 are not.

FIG. 6 is a conceptual illustration of different methods for constructing an envelope around a ligand, according to different embodiments of the invention. As shown, envelope 605 is constructed using the center of mass 540 of the ligand atoms. In one embodiment, center of mass 540 may be calculated by assigning each atom the same mass weighting. The positions are summed and then divided by the number of atoms, essentially finding the average position of an atom. Once the center of mass is found the atom furthest from the center of mass (atom 515) is found by iterating through each atom and calculating its distance away from the center of mass 540. The distance from the center of mass 540 to atom 515 may be used to define envelope 605 with radius 520.

Sometimes, the center of mass for a particular ligand envelope is skewed non-optimally by clusters of atoms. In such cases, an envelope 610 may be based on a “midpoint” of the ligand. This method assumes that the midpoint in each of the x, y, and z planes of all atoms in the ligand should define the center of envelope (e.g., envelope 610. In one embodiment, the midpoint 620 may be calculated by identifying the maximum and minimum position of any atom in the lingand in each of the x, y, and z dimensions, summing them and dividing by two. Once midpoint position 620 is identified, the atom furthest from midpoint 620 is again determined and the distance is used as the radius for the envelope (e.g., envelope 610).

Another technique for constructing a ligand envelope is to generate a three dimensional structure enclosing the ligand, such as a box 615. This technique assumes that a box can be drawn around the ligand atoms and used to quickly exclude receptor atoms. In one embodiment, the box may be determined by finding the minimum and maximum positions of the ligand atoms in each dimension. Each plane may then be used to quickly include/exclude receptor atoms by determining which side of the planes a given atom of the receptor falls.

Advantageously, embodiments of the invention provide a technique for reducing the number of actions performed as part of a molecular modeling simulation. For example, embodiments of the invention may be used to reduce the number of comparisons performed in a simulation of binding affinity between a ligand and receptor. Because such a simulation is typically performed a very large number of times for even a single ligand and receptor, the effect of reducing the number of comparisons is leveraged and can provide a significant impact on overall simulation performance.

While the foregoing is directed to embodiments of the present invention, other and further embodiments of the invention may be devised without departing from the basic scope thereof, and the scope thereof is determined by the claims that follow.

What is claimed is:

1. A computer-implemented method of excluding certain atoms from being included in a hydrogen bond (hbond) test performed as part of a computational simulation, comprising:
selecting a conformation for a first molecule and a second molecule to simulate, wherein the conformation includes a set of atoms in the first molecule, a set of atoms in the second molecule, and specifies a position of the first and second molecule, relative to one another;
determining a region of space for an envelope surrounding the set of atoms in the second molecule;
increasing the region of space enclosed by the envelope by an hbond distance;
determining which of the set of atoms of the first molecule are within the envelope surrounding the set of atoms in the second molecule; and
for each atom of the first molecule within the envelope surrounding the set of atoms in the second molecule, determining whether the atom of the first molecule is within a specified distance of any of the atoms of the second molecule.

2. The method of claim 1, further comprising, upon determining that none of the atoms of the first molecule determined to be within the envelope are also determined to be within the specified distance, simulating the interaction between the first and second molecule to estimate at least one of a binding affinity and a free energy state of the conformation of the first and second molecules.

3. The method of claim 1, wherein the hbond distance represents a distance over which hydrogen bonding interactions are expected to occur between the first molecule and the second molecule as part of the computation simulation.

4. The method of claim 1, wherein the specified distance represents a minimum distance between any atom of the first set of atoms and any atom of the second set of atoms required for the computational simulation.

5. The method of claim 1, wherein the envelope is constructed based on the center of mass of the second molecule.

6. The method of claim 1, wherein the envelope is constructed based on the geometric center of the second molecule.

7. The method of claim 1, wherein the envelope is constructed as a three dimensional box or other three-dimensional volume.

8. A computer-readable storage medium containing a program which, when executed, performs an operation for excluding certain atoms from being included in a hydrogen bond (hbond) test performed as part of a computational simulation, the operation comprising:
receiving a selection of a conformation for a first molecule and a second molecule to simulate, wherein the conformation includes a set of atoms in the first molecule, a set of atoms in the second molecule, and specifies a position of the first and second molecule, relative to one another;
determining a region of space for an envelope surrounding the set of atoms in the second molecule;
increasing the region of space enclosed by the envelope by an hbond distance;
determining which of the set of atoms of the first molecule are within the envelope surrounding the set of atoms in the second molecule; and
for each atom of the first molecule within the envelope surrounding the set of atoms in the second molecule, determining whether the atom of the first molecule is within a specified distance of any of the atoms of the second molecule.

9. The computer-readable storage medium of claim 8, wherein the operations further comprise, upon determining that none of the atoms of the first molecule determined to be within the envelope are also determined to be within the specified distance, simulating the interaction between the first and second molecule to estimate at least one of a binding affinity and a free energy state of the conformation of the first and second molecules.

10. The computer-readable storage medium of claim 8, wherein the hbond distance represents a distance over which hydrogen bonding interactions are expected to occur between the first molecule and the second molecule as part of the computation simulation.

11. The computer-readable storage medium of claim 8, wherein the specified distance represents a minimum distance between any atom of the first set of atoms and any atom of the second set of atoms required for the computational simulation.

12. The computer-readable storage medium of claim 8, wherein the envelope is constructed based on the center of mass of the second molecule.

13. The computer-readable storage medium of claim 8, wherein the envelope is constructed based on the geometric center of the second molecule.

14. The computer-readable storage medium of claim 8, wherein the envelope is constructed as a three dimensional box or other three-dimensional volume.

15. A computing device, comprising:
a compute node having at least a processer and a memory; and
a simulation program, which when exeucted by the compute node, performs an operation for excluding certain atoms from being included in a hydrogen bond (hbond) test performed as part of a computational simulation, the operation comprising:
receiving a selection of a conformation for a first molecule and a second molecule to simulate, wherein the conformation includes a set of atoms in the first molecule, a set of atoms in the second molecule, and specifies a position of the first and seclude molecule, relative to one another,
determining a region of space for an envelope surrounding the set of atoms in the second molecule,
increasing the region of space enclosed by the envelope by an hbond distance,
determining which of the set of atoms of the first molecule are within the envelope surrounding the set of atoms in the second molecule, and
for each atom of the first molecule within the envelope surrounding the set of atoms in the second molecule, determining whether the atom of the first molecule is within a specified distance of any of the atoms of the second molecule.

16. The computing device of claim 15, wherein the operations further comprise, upon determining that none of the atoms of the first molecule determined to be within the envelope are also determined to be within the specified distance, simulating the interaction between the first and second molecule to estimate at least one of a binding affinity and a free energy state of the conformation of the first and second molecules.

17. The computing device of claim 15, wherein the hbond distance represents a distance over which hydrogen bonding interactions are expected to occur between the first molecule and the second molecule as part of the computation simulation.

18. The computing device of claim 15, wherein the specified distance represents a minimum distance between any atom of the first set of atoms and any atom of the second set of atoms required for the computational simulation.

19. The computing device of claim 15, wherein the envelope is constructed based on the center of mass of the second molecule.

20. The computing device of claim 15, wherein the envelope is constructed based on the geometric center of the second molecule.

21. The computing device of claim 15, wherein the envelope is constructed as a three dimensional box or other three-dimensional volume.

22. The computing device of claim 15, wherein the computing device includes a plurality of compute nodes configured as a parallel computing system.
